(19) United States
(12) Patent Application Publication
(10) Pub. No.: US 2010/0322077 A1
(43) Pub. Date: Dec. 23, 2010

(54) ENVIRONMENT ANALYSIS SYSTEM AND METHOD FOR INDOOR WIRELESS LOCATION

(75) Inventors: Seong Yun Cho, Daejeong (KR); Wan Sik Choi, Daejeong (KR); Byung Doo Kim, Daejeong (KR); Young-su Cho, Daejeong (KR); Jong-Hyun Park, Daejeong (KR)

Correspondence Address: Jae Y. Park, Kile, Park, Goekjian, Reed & McManus, PLLC, 1200 New Hampshire Ave. NW, Suite 570, Washington, DC, 20036, US

(73) Assignee: Electronics and Telecommunications Research Institute, Daejeon (KR)

(21) Appl. No.: 12/446,349

(22) PCT Filed: Dec. 29, 2006
(86) PCT No.: PCT/KR06/05882

§ 371 Date: Apr. 20, 2009

(30) Foreign Application Priority Data
Nov. 7, 2006 (KR) 10-2006-0109443

(51) Int. Cl. H04L 12/26

(52) U.S. Cl. 370/241

(57) ABSTRACT

An environment analysis system for indoor wireless location by using locations of a plurality of access points (AP) includes, a first environment analysis tool (10) for receiving indoor environment information for indoor wireless location, performing a simulation for calculating location accuracies, performing a simulation for relocating and/or additionally installing the access points (AP), and displaying results of the simulation; and a second environment analysis tool (20) for receiving wireless communications signals from the access points (AP), calculating distances from the second environment analysis tool (20) to the access points (AP), calculating a location of the second environment analysis tool (20), calculating errors in the distances and in the location calculated, and providing the errors calculated to the first environment analysis tool (10). The first environment analysis tool (10) corrects errors in the simulations performed thereby by using the errors received from the second environment analysis tool (20), and then repeats the simulations and the displaying process.

### TECHNICAL FIELD

The present invention relates to an environment analysis system and method; and, more particularly, to an environment analysis system and method for indoor wireless location, wherein the system and the method are for understanding construction status of indoor location infrastructure by using wireless communications systems such as WLAN (Wireless Local Area Network), Bluetooth, UWB (Ultra Wideband), and the like and for ensuring location reliability.

### BACKGROUND ART

Since its development, a GPS (Global Positioning System) has been widely used as a location sensor in commercial car navigation systems. To be specific, by using location information of the car obtained via the GPS receiver, a variety of LBS (Location Based Services), e.g., a traffic guide, a location based information providing, and the like, is now provided.

However, there are drawbacks that the GPS receiver cannot provide location information continuously because it happens that the GPS receiver cannot receive a GPS satellite signal fully or partially in a room, a tunnel, an underground parking lot, a downtown area, etc.

Accordingly, a variety of studies on methods for indoor location, e.g., highly sensitive GPS receivers, DR (Dead Reckoning) methods for pedestrians using a MEMS (Micro Electro Mechanical System) based sensor, and wireless location using wireless communications signals, is on progress. At the present time, among these methods, great attention is being paid to studies (developments) on wireless location systems and methods which work in the same manner as GPS.

Indoor wireless location can be realized by using wireless communications systems such as WLAN, Bluetooth, and UWB, and the use of such systems has a merit that infrastructure for wireless communications has been already constructed indoors.

However, in the indoor wireless communications systems, since transmit powers of signals are restricted to prevent interferences therebeween, propagation distances of signals cannot be long. Also, an object to be located needs to be connected with at least three APs (Access Points) for wireless location, whereas a terminal is required to access only one AP for wireless communications. Thus, a sufficient infrastructure construction of APs is indispensable for indoor wireless location.

Further, in order to achieve high location accuracy, DOP (Dilution of Precision) value in a specific arrangement of the APs is required to be low. However, since APs already installed are located appropriately only for communications, relocations or additional installations of the APs are required for wireless location in a specific room.

Moreover, conventional studies on indoor location techniques are mainly focused on distance measurements for indoor location using wireless communications signals, location algorithms, error reduction methods, and the like; but developments of environment analysis tools for providing reliable indoor location services have not been studied yet.

### DISCLOSURE OF INVENTION

### Technical Problem

It is, therefore, an object of the present invention to provide an environment analysis system and method for indoor wireless location, wherein the system and the method are capable of analyzing an indoor environment for indoor wireless location, providing information on relocations or additional installations of APs to ensure location reliability by using a software tool, calculating a location by receiving wireless communications signals in the indoor environment by using a hardware tool, and correcting errors in the software tool by feeding the calculation result of the hardware tool back to the software tool.

### Technical Solution

In accordance with one aspect of the present invention, there is provided an environment analysis system for indoor wireless location by using locations of a plurality of access points, the system including:

a first environment analysis tool for receiving indoor environment information containing location information of the access points for indoor wireless location, performing a simulation for calculating location accuracies for all locations under conditions of the indoor environment information received, performing a simulation for relocating and/or additionally installing the access points according to the location accuracies calculated, and displaying results of the simulations; and

a second environment analysis tool for receiving wireless communications signals from the access points, calculating distances from the second environment analysis tool to the access points by using the wireless communications signals received, calculating a location of the second environment analysis tool by using the distances calculated, calculating errors in the distances and in the location calculated by comparing them with actual values thereof, and providing the errors calculated to the first environment analysis tool, wherein the first environment analysis tool corrects simulation errors by using the errors received from the second environment analysis tool, and then repeats the simulations and the displaying process.

In accordance with another aspect of the present invention, there is provided an environment analysis method for indoor wireless location by using locations of a plurality of access points, the method comprising the steps of:

receiving indoor environment information for indoor wireless location;

performing a simulation for calculating location accuracies for all locations under conditions of the indoor environment information received;

performing a simulation for relocating and/or additionally installing the access points according to the location accuracies calculated;

displaying simulation results;

calculating distances from a modem to the access points and a location of the modem by using wireless communications signals received therethrough from the access points;

calculating errors in the distances and in the location calculated by comparing them with actual values thereof; and

correcting simulation errors by using the errors calculated.

### Advantageous Effects

The present invention provides a simulation result on location accuracies in order to overcome limits of an indoor environment in which access points are already installed, and to provide reliable location information to a user by using wireless communications systems such as WLAN, Bluetooth, UWB, or the like. And also, the present invention provides a simulation result according to relocations and/or additional installations of the access points in order to provide an improved indoor environment for indoor location to the user.

Further, the present invention can correct simulation errors of a software tool by using a hardware tool, thereby providing more accurate environment analysis for indoor wireless location.

### BRIEF DESCRIPTION OF THE DRAWINGS

The above and other objects and features of the present invention will become apparent from the following description of preferred embodiments given in conjunction with the accompanying drawings, in which:

FIG. 1 is a schematic view showing a configuration of an environment analysis system for indoor wireless location in accordance with an embodiment of the present invention;

FIG. 2 describes a detail view showing a configuration of the environment analysis system for indoor wireless location shown in FIG. 1;

FIG. 3 provides an exemplary view showing indoor environment information provided to a software tool of the environment analysis system for indoor wireless location in accordance with the present invention; and

FIG. 4 sets forth an exemplary view showing error contour lines which are obtained by an indoor environment analysis in the software tool of the environment analysis system for indoor wireless location in accordance with the present invention.

### BEST MODE FOR CARRYING OUT THE INVENTION

Hereinafter, preferred embodiments of the present invention will be described in detail with reference to the accompanying drawings.

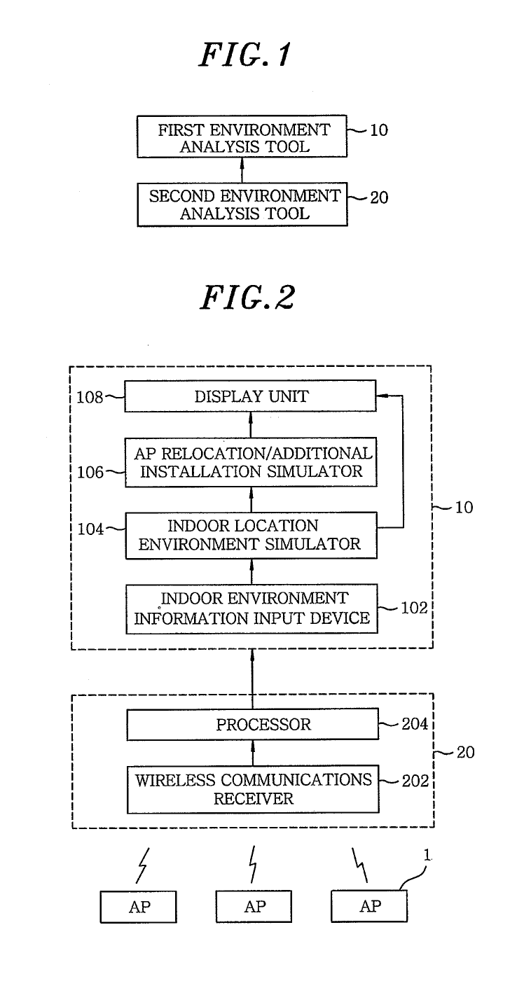

FIG. 1 is a schematic view showing a configuration of an environment analysis system for indoor wireless location in accordance with an embodiment of the present invention.

As shown in FIG. 1, the environment analysis system for indoor wireless location includes a first environment analysis tool 10 and a second environment analysis tool 20. Preferably, the first environment analysis tool 10 is a software tool and the second environment analysis tool 20 is a hardware tool.

The first environment analysis tool 10 receives indoor environment information which includes indoor map information, indoor wall information, and location information of access points, in order to analyze indoor environments appropriate for indoor wireless location by using wireless communications systems (e.g., WLAN, Bluetooth, UWB, and the like). Under conditions of the indoor environment information received, it performs a simulation for calculating indoor location accuracies for all locations in a room, and then performs a simulation for relocating and/or additionally installing the access points in the room according to the location accuracies calculated. After performing the simulations, the first environment analysis tool 10 displays results of the simulations.

The second environment analysis tool 20 receives wireless communications signals for indoor location from the access points to calculate its location and errors in the location calculated. And then, the second environment analysis tool 20 provides the location and the errors calculated to the first environment analysis tool 10.

Further, the first environment analysis tool 10 corrects its simulation errors by using the errors received from the second environment analysis tool 20.

FIG. 2 describes a detail view showing a configuration of the environment analysis system for indoor wireless location shown in FIG. 1.

The first environment tool 10 is for performing a simulation for analyzing environments for indoor location. As shown in FIG. 2, it includes an indoor environment information input unit 102 for receiving indoor environment information for indoor wireless location; an indoor location environment simulator 104 for performing a simulation for calculating location accuracies for all locations in the entire indoor area under conditions of the indoor environment information received; an AP relocation/additional installation simulator 106 for performing a simulation for relocating the APs 1 (Access Points) already installed and/or additionally installing a minimum number of APs 1 according to the location accuracies calculated; and a display unit 108 for displaying simulation results of the indoor location environment simulator 104 and the AP relocation/additional installation simulator 106.

The indoor environment information input unit 102 is for receiving the indoor environment information for indoor wireless location, wherein the indoor environment information includes indoor map information, indoor wall information, location information of the APs 1, transmit power information of the APs 1, movement information of a person, etc.

The indoor location environment simulator 104 calculates location accuracies (error probabilities) for all locations in the entire indoor area under conditions of the indoor environment information, and then provides a digital map image on which error contour lines are drawn to the display unit 108, wherein each error contour line is a line connecting locations at which location errors have an identical value. Further, the indoor location environment simulator 104 calculates percentage of area, at which the location accuracies satisfy reliability of a specific value in the entire indoor area, and provide the calculation result to the display unit 108. Herein, the calculation result includes three factors x, y, and z, wherein x, y, and z denote the percentage of indoor area, the location error, and the reliability, respectively. Accordingly, if x=90, y=1, and z=95, it indicates that 90% of the entire indoor area has location errors of 1 m with reliability of 95%, for example.

The AP relocation/additional installation simulator 106 is for inferring a method for satisfying reliability of a specific value. To be specific, it performs a simulation to verify that the relocations of the APs 1 already installed and/or additional installations of the APs 1 at specific locations can improve the reliability to the specific value.

The display unit 108 displays the simulation results of the indoor location environment simulator 104 and the AP relocation/additional installation simulator 106. To be specific, it displays the digital map image on which the error contour lines are drawn, information on the APs 1 which are relocated or additionally installed, and the like on display devices such as monitors.

Further, the second environment analysis tool 20 is for correcting errors in the first environment analysis tool 10. As shown in FIG. 2, it includes a wireless communications receiver 202 for receiving the wireless communications signals from the APs 1; and a processor 204 for calculating the location of the second environment analysis tool and the errors in the location calculated.

The wireless communications receiver 202 is configured with a modem for WLAN, Bluetooth, UWB, or the like. It receives the wireless communications signals from the APs 1 and delivers the signals received to the processor 204.

The processor 204 calculates the distances from the modem to the access points from which the modem receives the wireless communications signals, the location of the modem serving as the wireless communications receiver 202 by using the distances calculated and the location information of the APs 1, and the errors in the distances and in the location calculated by comparing them with the actual values thereof. Thereafter, it delivers the errors calculated to the first environment analysis tool 10.

The first environment analysis tool 10 corrects its simulation errors by using the errors received from the second environment analysis tool 20 in order to improve the performance of the indoor location environment simulator 104. Preferably, these processes are carried out in a manner of calculating the simulation errors of the first environment analysis tool 10 in the second environment analysis tool 20 and compensating the simulation errors in the first environment analysis tool 10 according to the errors calculated in the second environment analysis tool 20. Due to these feedback processes, i.e., processes for correcting the simulation errors in the first environment analysis tool 10 (software tool) by using the second environment analysis tool 20 (hardware tool), accuracy of the simulation results for analyzing indoor location accuracy can be improved.

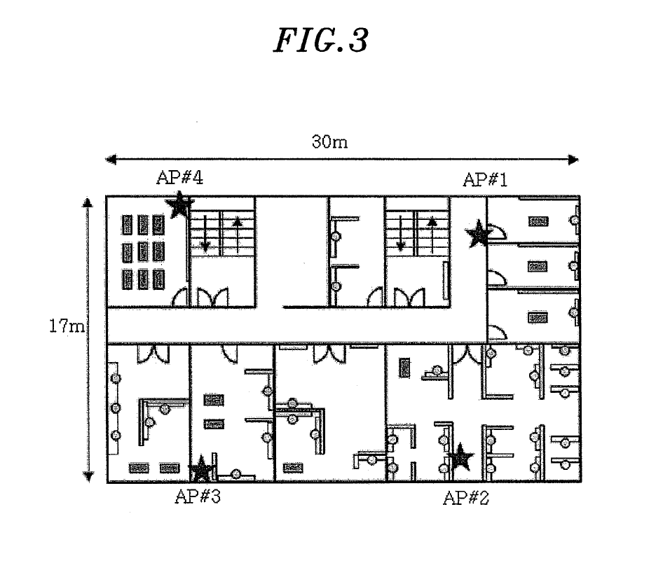

FIG. 3 provides an exemplary view showing indoor environment information provided to a software tool of the environment analysis system for indoor wireless location in accordance with the present invention.

As shown in FIG. 3, indoor map information (30 m and 17 m), indoor wall information, location information of the APs (AP#1, AP#2, AP#3, and AP#4) already installed, transmit power information of the APs, movement information of a person, and the like are digitized to be input into the indoor environment information input unit 102.

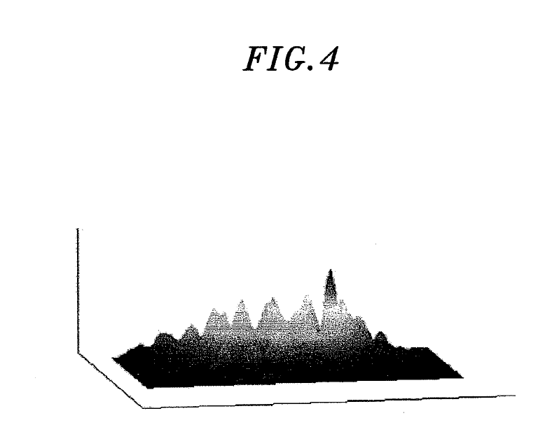

FIG. 4 sets forth an exemplary view showing error contour lines which are obtained by an indoor environment analysis in the software tool of the environment analysis system for indoor wireless location in accordance with the present invention.

Referring to FIG. 4, the environment analysis system in accordance with the present invention displays error contour lines on a digital map image as one of the results of the indoor location environment simulation which is performed under conditions of the indoor environment information input thereinto (see FIG. 3). In the error contour lines, since the height of each contour line corresponds to a magnitude of the location error, the magnitude of a location error is large at a location where the height of the contour line is high. Thus, the error contour lines are used in calculating a ratio of the area where the location error is larger than a specific threshold value to the entire indoor area. Further, by checking the height of the error contour line at a main location, it can be found how to relocate the APs and/or where additional APs need to be installed.

Hereinafter, the environment analysis method for indoor wireless location in accordance with the present invention will be described with reference to FIG. 2.

The wireless communications receiver 202 of the second environment analysis tool 20 receives the wireless communications signals from the APs 1 disposed in an indoor environment via a modem (e.g., a modem for WLAN, Bluetooth, UWB, or the like), and it delivers the wireless communications signals received to the processor 204.

After receiving the wireless communications signals, the processor 204 of the second environment analysis tool 20 calculates the distances from the wireless communications receiver 202 to the APs 1 from which it receives the signals, the location of the wireless communications receiver 202 by using the distances calculated and the location information of the APs 1, and the errors in the distances and in the location calculated. And then, the processor 204 delivers the errors calculated to the first environment analysis tool 10.

Next, the indoor environment information input unit 102 of the first environment analysis tool 10 is input thereinto indoor environment information for indoor location (such as indoor map information, indoor wall information, location information of the APs 1 already installed, transmit power of the APs 1, movement information of a person, and the like), or receives the errors on the distances from the modem to the APs 1 and the location of the modem calculated from the second environment analysis tool 20. And then, the indoor environment information input unit 102 delivers them to the indoor location environment simulator 104.

Thereafter, the indoor location environment simulator 104 of the first environment analysis tool 10 calculates location accuracies at each location in the entire indoor area under conditions of the indoor location information or after correcting the simulation errors by using the errors received from the second environment analysis tool 20. And then, the indoor location environment simulator 104 provides the location accuracies in a form of a digital map image on which error contour lines are drawn to the display unit 108.

Subsequently, the AP relocation/additional installation simulator 106 of the first environment analysis tool 10 performs a simulation for finding how to make the location accuracies calculated by the indoor location environment simulator 104 satisfy reliability of a specific value by relocating the APs 1 already installed or additionally installing the minimum numbers of APs 1 at specific locations.

After that, the display unit 108 of the first environment analysis tool 10 displays results of the simulations performed by the indoor location environment simulator 104 and the AP relocation/additional installation simulator 106. To be specific, it displays the digital map image on which the error contour lines are drawn and graphical information on the relocation and/or the additional installation of the APs 1, on a display device such as a monitor.

While the invention has been shown and described with respect to the preferred embodiments, it will be understood by those skilled in the art that various changes and modifications may be made without departing from the scope of the invention as defined in the following claims.

1. An environment analysis system for indoor wireless location by using locations of a plurality of access points, the system comprising:
a first environment analysis tool for receiving indoor environment information containing location information of the access points for indoor wireless location, performing a simulation for calculating location accuracies for all locations in the entire indoor area under conditions of the indoor environment information received, performing a simulation for relocating and/or additionally installing the access points according to the location accuracies calculated, and displaying results of the simulations; and
a second environment analysis tool for receiving wireless communications signals from the access points, calculating distances from the second environment analysis tool to the access points by using the wireless communications signals received, calculating a location of the second environment analysis tool by using the distances calculated, calculating errors in the distances and in the location calculated by comparing them with actual values thereof, and providing the errors calculated to the first environment analysis tool, wherein the first environment analysis tool corrects errors in the simulations performed thereby by using the errors received from the second environment analysis tool, and then repeats the simulations and the displaying process.

2. The environment analysis system of claim 1, wherein the first environment analysis tool includes,
an indoor environment information input unit for receiving indoor environment information for indoor wireless location;
an indoor location environment simulator for performing the simulation for calculating the location accuracies for all locations in the entire indoor area under conditions of the indoor environment information received;
an AP relocation/additional installation simulator for performing the simulation for relocating and/or additionally installing the access points according to the location accuracies calculated; and
a display unit for displaying the results of the simulations.

3. The environment analysis system of claim 2, wherein the indoor environment information input unit receives the indoor environment information including indoor map information, indoor wall information, location information of the access points, transmit power information of the access points, and movement information of a person.

4. The environment analysis system of claim 2, wherein the indoor location environment simulator includes,
a unit for calculating the location accuracies for all locations in the entire indoor area under conditions of the indoor environment information;
a unit for calculating percentage of area, at which the location accuracies satisfy reliability of a specific value, in the entire indoor area; and
a unit for providing a digital map image on which error contour lines are drawn to the display unit, wherein each error contour line is a line connecting locations at which location errors have an identical value.

5. The environment analysis system of claim 1, wherein the second environment analysis tool includes,
a wireless communications receiver for receiving the wireless communications signals from the access points; and
a processor for calculating the distances from the second environment analysis tool to the access points, the location of the second environment analysis tool, and the errors in the distances and in the location calculated.

6. An environment analysis method for indoor wireless location by using locations of a plurality of access points, the method comprising the steps of:
receiving indoor environment information for indoor wireless location;
performing a simulation for calculating location accuracies for all locations in the entire indoor area under conditions of the indoor environment information received;
performing a simulation for relocating and/or additionally installing the access points according to the location accuracies calculated;
displaying simulation results;
calculating distances from a modem to the access points and a location of the modem by using wireless communications signals received therethrough from the access points;
calculating errors in the distances and in the location calculated by comparing them with actual values thereof; and
correcting errors in the simulations by using the errors calculated.

7. The environment analysis method of claim 6, wherein the step for performing a simulation for calculating location accuracies for all locations in the entire indoor area includes a step for providing a digital map image on which error contour lines are drawn to the display unit, wherein each error contour line is a line connecting locations at which location errors have an identical value.
